(19) United States
(12) Patent Application Publication
(10) Pub. No.: US 2017/0228220 A1
(43) Pub. Date: Aug. 10, 2017

(54) SELF-HEALING AUTOMATED SCRIPT-TESTING TOOL

(71) Applicant: International Business Machines Corporation, Armonk, NY (US)

(72) Inventors: Guang Yu Dai, Ningbo (CN); Jing Bo Jiang, Beijing (CN); Wen Jing Wang, Beijing (CN); Ying Wang, Beijing (CN); Xin Xu, Beijing (CN); Jie Zheng, Beijing (CN)

(21) Appl. No.: 15/017,696

(22) Filed: Feb. 8, 2016

(51) Int. Cl. G06F 9/44; G06F 11/36

(52) U.S. Cl. CPC G06F 8/38; G06F 11/362

(57) ABSTRACT

A method and associated systems for a self-healing automated script-testing tool. The tool monitors unattended operation of a script that automates user interaction with a graphical user interface (GUI) of an application. If the tool detects an error produced by the script, the tool, using its specialized repositories of information about the script, the GUI, and the application, determines that the error is caused by an addition of a mandatory widget to, or a deletion of a mandatory widget from, the GUI. The tool uses information in the repositories to revise the script and, if the error is caused by a widget addition, to select test data that may be used to test the script's interaction with the new widget. The script and the repositories are then revised and the revised script is automatically retested. This procedure continues until the script runs successfully without error.

### TECHNICAL FIELD

The present invention relates to tools for automatically repairing scripts that automate interactions with computer software.

### BACKGROUND

User interactions with a software application's graphical user interface (GUI) may be automated by means of a GUI script that, running unattended, interacts with the GUI in order to reproduce the user's actions.

GUI scripts can provide improvements in productivity by automating complex tasks that, in an active computing environment, may fail whenever a GUI is modified. If, for example, a mandatory input field is added to a screen, a script that was written to interact with that screen before that field existed will cause an error by failing to enter data into that field.

Automated test tools that debug GUI scripts may detect a failure of a running script, but may not be able to identify a source of such a failure unless the test tool has been manually updated to account for recent GUI updates. Timely updating, however, is difficult in a large-scale computing environment where a GUI may be updated frequently by one or more independent parties that are not in close contact with each other or with GUI-script developers. Unattended GUI scripts may therefore suddenly begin to fail in unexpected ways that cannot be corrected until a script-maintenance specialist is alerted to the failure and is able to analyze the problem. Because scripts are often run after-hours unattended, this means that a mission-critical script may be disabled for an entire evening or weekend.

A few script-testing tools may be able to automatically heal some types of script errors, such as those caused by moving a field to a different location on a screen, by adding or subtracting a non-mandatory widget, or by changing a required data format of an input field. But such tools are not able to access resources that would let them automatically correct more severe or more nuanced problems, such as a failure that is caused by an addition of a new mandatory input field to a screen, or by a deletion of an existing mandatory input field from a screen. Nor can such tools determine how to generate proper test data for newly added fields in order to reliably test a GUI script that has been revised in an attempt to cure such an error.

There is thus a need for an intelligent GUI-testing tool that automatically detects a GUI script failure, maintains and uses information repositories to determine whether the failure is caused by an addition or deletion of a mandatory widget to or from a screen of the GUI, automatically revises the GUI script to account for the addition or deletion, and then selects appropriate test data that allows the testing tool to verify that the revised script works properly with the latest version of the application's GUI.

There is a further need for such an intelligent tool to operate autonomously, repairing a failed script without user intervention, such that the failure does not significantly interrupt unattended performance of the automated operations that the script performs.

### BRIEF SUMMARY

A first embodiment of the present invention provides An automated script-healing system comprising a processor of a computer, a memory coupled to the processor, and a computer-readable hardware storage device coupled to the processor, the storage device containing program code configured to be run by the processor via the memory to implement a method for self-healing automated script-healing tool, the method comprising:

the system detecting a failure in a script that interacts with a graphical user interface of a software application;

the system determining that the failure is caused by an addition of a mandatory widget to the graphical user interface or by a deletion of a mandatory widget from the graphical user interface;

the system revising the script to correct the error; and

the system automatically retesting the revised script to determine whether the revision has corrected the error.

A second embodiment of the present invention provides a method for a self-healing automated script-testing tool, the method comprising:

a processor of a computer detecting a failure in a script that interacts with a graphical user interface of a software application;

the processor determining that the failure is caused by an addition of a mandatory widget to the graphical user interface or by a deletion of a mandatory widget from the graphical user interface;

the processor revising the script to correct the error; and

the processor automatically retesting the revised script to determine whether the revision has corrected the error.

A third embodiment of the present invention provides a computer program product, comprising a computer-readable hardware storage device having a computer-readable program code stored therein, the program code configured to be executed by an automated script-healing system comprising a processor, a memory coupled to the processor, and a computer-readable hardware storage device coupled to the processor, the storage device containing program code configured to be run by the processor via the memory to implement a method for a self-healing automated script-testing tool, the method comprising:

the processor detecting a failure in a script that interacts with a graphical user interface of a software application;

the processor determining that the failure is caused by an addition of a mandatory widget to the graphical user interface or by a deletion of a mandatory widget from the graphical user interface;

the processor revising the script to correct the error; and

the processor automatically retesting the revised script to determine whether the revision has corrected the error.

### BRIEF DESCRIPTION OF THE DRAWINGS

FIG. 1 shows the structure of a computer system and computer program code that may be used to implement a method for a self-healing automated script-testing tool in accordance with embodiments of the present invention.

FIG. 2 shows relationships among components of the present invention.

FIG. 3 is a flow chart that illustrates steps of a method for a self-healing automated script-testing tool.

### DETAILED DESCRIPTION

Embodiments of the present invention provide systems and methods for: automatically detecting a failure of a script used to automate user interactions with a graphical user interface (GUI); identifying that the failure is related to an addition or a deletion of a mandatory widget from the GUI; determining from extrinsic data sources how to rectify the problem by revising the script and related documents; revising the script and automatically generating appropriate input data if needed to test the revised script's ability to handle a newly added widget; retesting the script with the new data; and repeating the procedure until the script runs without error.

Unlike existing attempts at automated GUI-script maintenance tools, embodiments of the present invention may run unattended, automatically determining when a script has failed due to an unexpected GUI change, identifying likely causes of the failure, revising the script with candidate solutions until it successfully cures the failure, and generating new test procedures that allow automated test tools to confirm that the revised script has no further problems.

In addition, the present invention further comprises a novel method of using information stored in extrinsic information repositories, and in repositories that the invention itself maintains, to automatically select and format proper test data that lets the testing tool confirm that the revised script continues to interact successfully with the GUI.

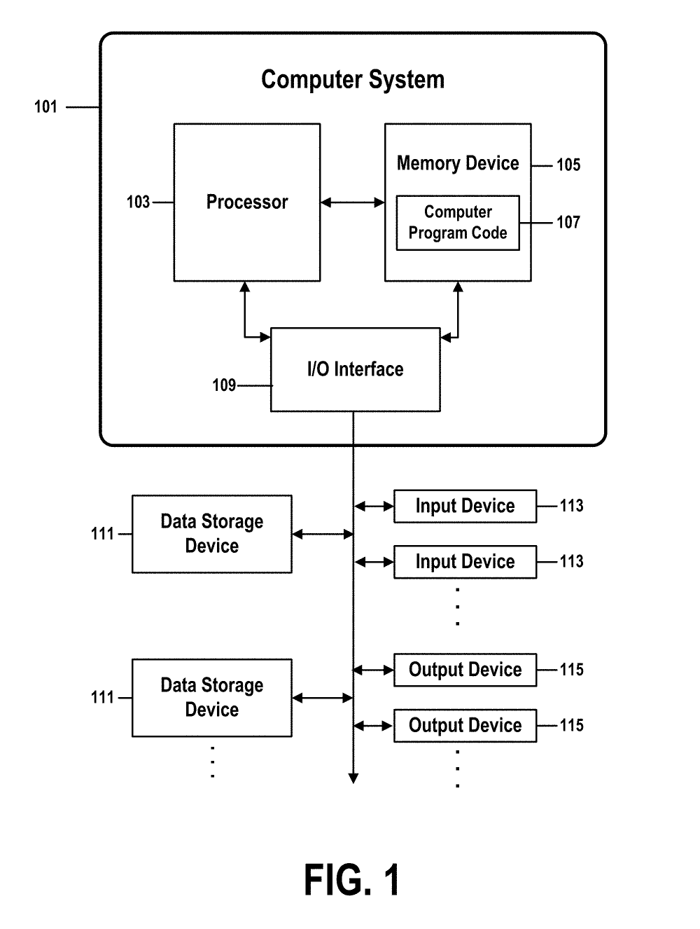

FIG. 1 shows a structure of a computer system and computer program code that may be used to implement a method for a self-healing automated script-testing tool in accordance with embodiments of the present invention. FIG. 1 refers to objects 101-115.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for a self-healing automated script-testing tool in accordance with embodiments of the present invention, and may implement other embodiments described in this specification, including the methods illustrated in FIGS. 1-3. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for a self-healing automated script-testing tool.

Any of the components of the present invention could be created, integrated, hosted, maintained, deployed, managed, serviced, supported, etc. by a service provider who offers to facilitate a method for a self-healing automated script-testing tool. Thus the present invention discloses a process for deploying or integrating computing infrastructure, comprising integrating computer-readable code into the computer system 101, wherein the code in combination with the computer system 101 is capable of performing a method for a self-healing automated script-testing tool.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for a self-healing automated script-testing tool may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for a self-healing automated script-testing tool is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

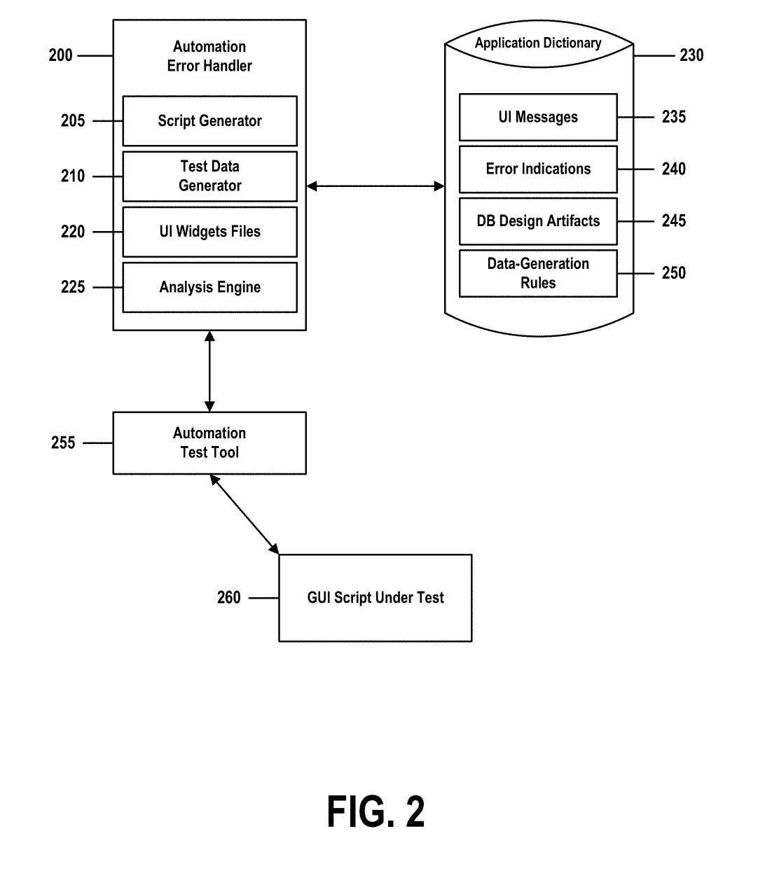

FIG. 2 shows relationships among components of the present invention. FIG. 2 comprises items 200-260. Each of these components may be implemented as real or virtual entities on a computer network or cloud-computing platform. Some or all of them may be distinct, independent software programs or computerized systems, or may be integrated together as elements of a single, combined module.

Embodiments of the present invention are intended to operate in an environment in which a test tool 255 tests the operation of a script 260 that is designed to automate common user interactions with a graphical user interface of an application. In such embodiments, when test tool 255 detects an error in the operation of the script, error handler 200, using information culled from an application dictionary 230, then attempts to automatically repair the script.

Automation test tool 255 is a software module or modules that test automated scripts in order to determine if the scripts operate correctly. Such a test tool may evaluate a script by running the script with predetermined test data that produces a successful result only if the script functions correctly. If, for example, a GUI requires entry of a valid account number, the test tool 255 might test the script by loading it with test data comprising a valid, properly formatted number.

Automation error handler 200 is a software module or modules that respond to errors produced by automated scripts that may be running unattended in a production environment. When error handler 200 identifies such an error, it automatically attempts to correct the error by revising the script and to generate any new test data needed by test tool 255 to confirm that the revised script is now operating correctly. Automation Error Handler 200 comprises modules 205-225.

Application dictionary 230 is a repository for data and logic that is used by the application associated with the GUI. It may store information needed by the application to communicate with users, respond to errors, or manage associated databases. In some embodiments, automation error handler 200 may use one or more repositories of information comprised by application dictionary 230 to identify and classify script errors, to determine how to revise a script in order to rectify such errors, and to generate test data required by the test tool 255 to determine whether the previously failing script can now automate GUI 260 without error.

Application dictionary 230 comprises one or more of four modules: a repository of UI messages 235, a repository of error indications 240, a repository of database design artifacts 245, and a repository of stored data-generation rules 250.

The repository of UI messages 235 stores one or more sets of textual messages that may be generated by the automation test tool 255, the script under test 260, the GUI being automated, or the application during playback of script 260. These messages may indicate an occurrence of one or more errors or of one or more successful completions of a task, and may be selected in response to the GUI's identification of an error condition or of a successful completion of a task.

If, for example, a script attempts to complete a screen of application GUI 260 that contains a mandatory “Address” input field, the script 260, GUI being automated, or application may respond by displaying a message: “The address you entered has been revised to a standard format. Do you wish to keep this standardized address?” “You must enter an address,” or “The address field does not contain valid data.” In such an example, the displayed message would be stored in the repository of UI messages 235, making it available to error handler 200 for diagnostic purposes.

The repository of error indications 240 stores one or more graphical objects that may be generated by the automation test tool 255, the script under test 260, the GUI being automated, or the application during playback of script 260. These objects may indicate an occurrence of one or more errors or of one or more successful completions of a task, and may be selected in response to the GUI's identification of an error condition or of a successful completion of a task. In cases in which a time at which an object is displayed on a screen, a location on the screen at which an object is displayed, or a position within a sequence of actions in which an object is displayed, is relevant, that information may also be stored in repository 240.

For example, in the above example, if a script fails to enter input data into the mandatory Address field, the application, by means of GUI might display a red exclamation point icon next to the Address field immediately after the data is entered. But if the script enters proper data to all input fields on the screen, the GUI might instead respond by displaying a “Next” button at the bottom of the screen.

The repository of database design artifacts 245 stores information characterizing data or logic associated with the application, such as a database schema or model file, design documents, or SQL scripts. Analysis engine 255 may use some or all of these artifacts, such as a data type, length, or acceptable range of values of a data element to identify data-generation rules.

For example, if the GUI under test 260 comprises a “Zip Code” field, information in repository of database design artifacts 245 might identify that the Zip Code field accepts input that comprises only five numeric digits.

The set of stored data-generation rules 250 may store data-generation rules that may comprise or elaborate upon some of the information stored in the repository of database design artifacts 245. In embodiments in which such rules 250 may not be available for all possible generated data, analysis engine 255 may be forced to derive a data-generation rule from other information stored in application dictionary 230.

If, for example, the GUI's Zip Code field can accept both five-digit and “Zip+4” SPS Zip codes, a rule stored in the rule repository 250 might identify that input data used to test this field must consist of either: five numeric digits; or five numeric digits followed by a hyphen and then by four numeric digits.

Automation error handler 200 comprises a script generator 205, a test data generator 210, a UI widgets file 220, and an analysis engine 225.

Script generator 205 generates a revised version of GUI script 260 that incorporates revisions selected by analysis engine 255 in order to resolve detected errors in the script.

Test data generator 210 automatically generates input data that may be used by automation test tool 255 when determining whether revised GUI script 260 interacts correctly with the application GUI.

If, for example, the script 260 has been revised in order to account for a newly identified mandatory input widget, test data generator 210 might select input data that revised script 260 attempts to enter into the newly identified widget in order to determine whether revised script 260 interacts correctly with the newly identified widget.

UI widgets file 220 stores a list of some or all of the widgets comprised by the GUI under test. These widgets may comprise input fields, radio buttons, drop-down lists, drop-down menus, and other types of objects that may interact with a user.

Widgets file 220 may further store characteristics of each stored widget that may be useful in determining how to test the widget. Such characteristics may comprise, but are not limited to, a logical name of the widget, the data type, length, and format of the data it accepts or displays, a range of data values that it recognizes, a page or a location on a page at which the widget is displayed, or a condition that must be satisfied in order for the widget to be displayed.

Some embodiments of the present invention may automatically update widgets file 220 in response to a determination that a widget has been removed from or added to the application GUI.

Analysis engine 225 is a software module that uses information culled from other modules of error handler 200 and application dictionary 230 to identify a cause of a failure of a test script 260, and to further identify a corrective action that may be used to revise the script.

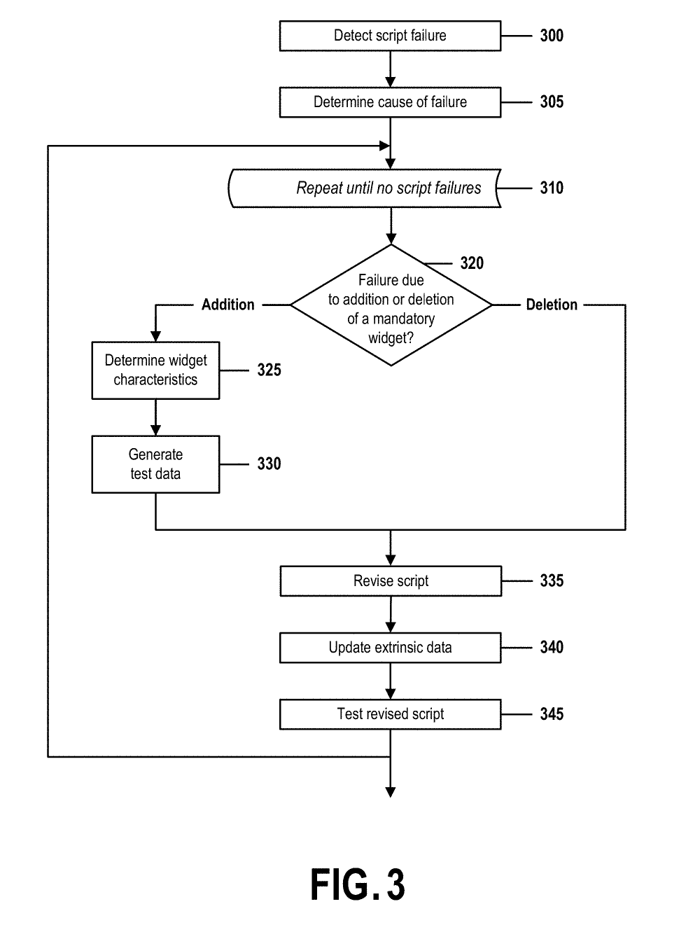

FIG. 3 is a flow chart that illustrates steps of a method for a self-healing automated script-testing tool. FIG. 3 comprises steps 300-345.

In step 301, automation error handler 200 determines that an error has occurred in a test script that may be running unattended. In embodiments and examples described in this document, this test script may be designed to automate an operation of a graphical user interface of a software application. But other embodiments of the present invention may perform steps analogous to those of FIG. 3 in order to automatically detect and correct errors in other types of software programs or modules that run to some extent unattended or without direct user intervention. Some embodiments may, for example, apply a method of FIG. 3 to a batch job of a transaction-processing system, or to an automatic update function of an operating system.

In some embodiments, the determination that an error has occurred may be reported by the GUI, by the failed test script 260, by the automation test tool 255, by the application, or by a reporting or system-maintenance module.

In some embodiments, the analysis engine 225 may proactively determine that an error has occurred by monitoring or by periodically examining an error log associated with the application or with a platform or network associated with the application.

In step 305, the analysis engine 225 attempts to determine a cause of the failure. This determination may be performed as a function of information stored in one or more modules of application dictionary 230 or in UI widgets files 220.

Analysis engine 225 may, for example, refer to error messages stored in UI repository 235 or to icons stored in the error indications repository 240 in order to identify the error. If, for example, immediately after a script attempts to enter address data into an “Address” field of GUI 260, a “stop sign” icon is loaded into the indications repository 240 or a message “Invalid data” is loaded into UI messages repository 235, then analysis engine 225 may infer that the problem is related to the attempted entry of address data. If the input data entered into the address field is known to be good, then analysis engine 225 may infer that a characteristic of the Address field has changed. If each subsequent attempt to enter data into the same screen generates a similar error, then the analysis engine 225 may infer that the “address” error occurred because the order of fields or the total number of fields on the screen has changed, resulting in the script attempting to enter data into fields other than those that it expects.

In other cases, information stored in the repository of database design artifacts 245 or in the UI widgets files 220 may provide further information from which analysis engine 225 may identify a cause of the failure. In one example, if such information identifies that a GUI “Zip Code” field was recently modified to accept only five-digit Zip codes, the analysis engine 225 may determine that the script error was caused by the script's attempt to enter a 10-character string into the Zip Code field.

Embodiments may comprise other types of determination methods that are logical extensions of the above examples. In some cases, an embodiment may infer conclusions by identifying relationships among multiple elements of stored information. In one example, analysis engine 225 may determine that a widget has been removed from a screen when it determines that an icon signifying invalid entry is detected in the error indications repository 240 and a message “Click Next to Continue” is detected in the UI messages repository 235. In this example, analysis engine 225 may assume that the error is caused by an attempt to enter data into a nonexistent field, thus causing the GUI to display a prompt that would not be generated unless the screen had already been completely filled in.

Step 310 begins an iterative procedure of steps 310-345 that continues to run until the GUI script 260 completes without error. Each iteration of this procedure attempts to resolve a most recently detected script error by revising the script and then tests the revised script to determine if it still fails.

Step 320 is a conditional decision-making block that determines whether the failure detected in step 300 was determined in step 305 to be caused by an addition of a mandatory widget to the GUI being automated, or by a deletion of a mandatory widget from the GUI being automated. If caused by an addition, the method of FIG. 3 continues with steps 325 and 330. If caused by a deletion, the method of FIG. 3 proceeds directly to step 335, skipping steps 325 and 330.

In some embodiments, step 320 may be interpreted as a case statement by adding additional logical branches. In one example, if step 305 determines that the error detected in step 300 was caused by a change to a size of an input widget, step 320 may contain a third branch that is performed when such a determination is made. That third branch might comprise additional steps needed to identify how to properly revise the failed script 260 in step 335. Other types of conditions may be detected and addressed in step 320, and in any additional steps required to identify a method of revising the script 260 in order to address the failure.

Step 325 is performed when the error-handler 200 determines in step 305 that the failure detected in step 300 was caused by an addition of a mandatory widget to the GUI being automated.

As described in FIG. 2, analysis engine 225 may use information stored in the application dictionary 230 or in the UI widget file 220 to determine characteristics of the new widget.

As described in FIG. 2, information needed to make this determination may be comprised by details of the error message stored in the repository of UI messages 235 or in the repository of UI indications 240.

In more sophisticated embodiments, analysis engine 225 may further determine the characteristics by considering logical and data elements of the database design artifacts repository 245. HI-ere, analysis engine 225, after determining that the missing widget is associated with a parent widget, might guess that the missing widget shares at least some of its characteristics with its parents.

Consider, for example, a database artifacts repository 245 that identifies a “User_Information” table comprising User_Name, User_Address, and User_Account_Number field. If the failing script 260 enters a user name and a user address into a “User Information” screen of the GUI, but does not enter an account number, analysis engine 225 may guess that a missing-widget error on that page was caused by an addition of an input field that requires entry of an account number. Analysis engine 225 might then determine that a most likely method of resolving the error would be to revise script 260 to submit a user account number on the error-producing page. In this case, likely characteristics of that missing widget would match those of the User_Account_Number field of the database artifact repository 245.

In another example, data-generation rules 250 may indicate characteristics of the input data required by a newly added widget that comprise, but are not limited to, a data type, a data size, or a data format, or may indicate a range of values that are compatible with the added widget. If, for example, a widget comprises a first nested drop-down list that allows a user to select a month of the year and a context-sensitive second drop-down list that allows the user to select a day of the selected month, then the test data used to test the script's 260 ability to interact properly with the GUI would necessarily be limited to a first selection of a valid month and a second selection of a valid day of the selected month.

In step 330, the analysis engine 225 generates test data that may be used by the automation test tool 255 to determine whether actions of the error handler 200 have corrected the error detected in step 305. This test data may be generated as a function of data characteristics identified in step 245, of data-generation rules identified in step 250, and of other information that may be stored in modules of the application dictionary 230 and of the UI widgets files 220.

In some embodiments, step 325 or step 330 may be performed by a different module of the error handler 200, such as the test generator module 210 or the script generator 205.

In step 335, the script generator 205, as a function of determinations made in earlier steps of FIG. 3, revises the GUI script under test 260.

If the analysis engine 225 determined in step 320 that the script 260 had previously failed because a mandatory widget had been removed from the GUI, the revision may comprise removing steps of the script 260 that attempt to submit test data to the removed widget.

If the analysis engine 225 determined in step 320 that the script 260 had previously failed because a mandatory widget had been added to a screen of the GUI, the revision may comprise adding steps of the script 260 that attempt to submit test data generated in step 330 to the added widget.

In step 340, the error-handler 200 updates any repositories of information 220 or 235-250 that may have been affected by determinations of FIG. 2. If, for example, the analysis engine 225 determines that the error of step 300 was caused by removal of a mandatory widget, analysis engine 225 may remove references to that widget from the UI widgets file 220. Similarly, if the analysis engine 225 determines that the error of step 300 was caused by addition of a mandatory widget, analysis engine 225 may add an entry for that widget to the UI widgets file 220, including values of any characteristic of the widget that is identified in the UI widgets file 220.

In some embodiments, this updating is performed only after the test tool 255 in step 345 determines that the revisions made in step 335 were successful in curing the most recently identified error.

In step 345, the automation test tool 255 receives from the error handler 200 the revised test script generated in step 335 and any new test data generated in step 330. The test tool 255 then runs the script to determine whether the revisions have cured the error most recently detected in step 300 or step 345.

If the error recurs, or if a new error occurs, the iterative procedure of steeps 310-345 are repeated in order. In this next iteration, the error handler 200 again attempts to revise the script 260 to cure the detected error.

If the error detected in the most recent iteration of step 345 has recurred, the error handler 200 revises the script 260 with its next-best guess at a resolution. If the error handler 200 cannot identify any further candidate solutions, a system administrator or other responsible party is notified that the script 260 has failed and cannot be automatically self-healed. If the error detected in the most recent iteration of step 345 is a new error, the iterative procedure of steps 310-345 are repeated in order to identify a most likely cause of that new error and to rectify the new error as a result of that identification.

In some embodiments, the method of FIG. 3 may continue in this manner until no further curable errors are found in script 260. In such cases, the method of FIG. 3 will resume automatically the next time an error in a GUI script is identified.

In other embodiments, the entire method of FIG. 3, steps 300-345, will continue to run autonomously, continually monitoring error logs or other error-reporting mechanisms, or waiting for a receipt of a detection of an error from a third-party or extrinsic source. In these embodiments, upon completion of a last iteration of the iterative procedure of steps 310-345, the method of FIG. 3 might automatically resume with step 300, where it waits until detecting another script failure.

1. An automated script-healing system comprising a processor of a computer, a memory coupled to the processor, and a computer-readable hardware storage device coupled to the processor, the storage device containing program code configured to be run by the processor via the memory to implement a method for self-healing automated script-healing tool, the method comprising:
the system detecting a failure in a script that interacts with a graphical user interface of a software application;
the system determining that the failure is caused by an addition of a mandatory widget to the graphical user interface or by a deletion of a mandatory widget from the graphical user interface;
the system revising the script to correct the error; and
the system automatically retesting the revised script to determine whether the revision has corrected the error.

2. The system of claim 1, wherein the revising is performed as a function of a set of information repositories maintained by the system.

3. The system of claim 2, wherein the set of information repositories comprises a repository of information characterizing widgets displayed by the graphical user interface.

4. The system of claim 3, wherein the set of information repositories further comprises:
a repository of characteristics of text and graphical objects displayed by the graphical user interface in response to the interface's detection of an error condition,
a repository of information characterizing data and logic of a database associated with the application, and
a repository of data-generation rules governing creation of test data that can be used by an automated script-testing program to confirm proper operation of the graphical user interface.

5. The system of claim 4, wherein the failure is caused by an addition of a mandatory widget to the graphical user interface, the method further comprising:
the system determining characteristics of the mandatory widget as a function of the repository of information characterizing widgets; and
the system generating the test data as a function of the repository of data-generation rules.

6. The system of claim 2, wherein the revising further comprises updating one or more repositories of the set of information repositories, and wherein the updating records the addition or deletion and identifies the revisions made to the script.

7. The system of claim 1, further comprising:
the system repeating the detecting, determining, revising, and retesting until the retesting determines that the revised script runs without error.

8. A method for a self-healing automated script-testing tool, the method comprising:
a processor of a computer detecting a failure in a script that interacts with a graphical user interface of a software application;
the processor determining that the failure is caused by an addition of a mandatory widget to the graphical user interface or by a deletion of a mandatory widget from the graphical user interface;
the processor revising the script to correct the error; and
the processor automatically retesting the revised script to determine whether the revision has corrected the error.

9. The method of claim 8, wherein the revising is performed as a function of a set of information repositories maintained by the processor.

10. The method of claim 9, wherein the set of information repositories further comprises:
a repository of characteristics of text and graphical objects displayed by the graphical user interface in response to the interface's detection of an error condition,
a repository of information characterizing data and logic of a database associated with the application,
a repository of data-generation rules governing creation of test data that can be used by an automated script-testing program to confirm proper operation of the graphical user interface, and
a repository of information characterizing widgets displayed by the graphical user interface.

11. The method of claim 10, wherein the failure is caused by an addition of a mandatory widget to the graphical user interface, the method further comprising:
the processor determining characteristics of the mandatory widget as a function of the repository of information characterizing widgets; and
the processor generating the test data as a function of the repository of data-generation rules.

12. The method of claim 9, wherein the revising further comprises updating one or more repositories of the set of information repositories, and wherein the updating records the addition or deletion and identifies the revisions made to the script.

13. The method of claim 8, further comprising:
the processor repeating the detecting, determining, revising, and retesting until the retesting determines that the revised script runs without error.

14. The method of claim 8, further comprising providing at least one support service for at least one of creating, integrating, hosting, maintaining, and deploying computer-readable program code in the computer system, wherein the computer-readable program code in combination with the computer system is configured to implement the detecting, determining, revising, and retesting.

15. A computer program product, comprising a computer-readable hardware storage device having a computer-readable program code stored therein, the program code configured to be executed by an automated script-healing system comprising a processor, a memory coupled to the processor, and a computer-readable hardware storage device coupled to the processor, the storage device containing program code configured to be run by the processor via the memory to implement a method for a self-healing automated script-testing tool, the method comprising:
the processor detecting a failure in a script that interacts with a graphical user interface of a software application;
the processor determining that the failure is caused by an addition of a mandatory widget to the graphical user interface or by a deletion of a mandatory widget from the graphical user interface;
the processor revising the script to correct the error; and
the processor automatically retesting the revised script to determine whether the revision has corrected the error.

16. The computer program product of claim 15, wherein the revising is performed as a function of a set of information repositories maintained by the processor.

17. The computer program product of claim 16, wherein the set of information repositories further comprises:
a repository of characteristics of text and graphical objects displayed by the graphical user interface in response to the interface's detection of an error condition,
a repository of information characterizing data and logic of a database associated with the application,
a repository of data-generation rules governing creation of test data that can be used by an automated script-testing program to confirm proper operation of the graphical user interface, and
a repository of information characterizing widgets displayed by the graphical user interface.

18. The computer program product of claim 17, wherein the failure is caused by an addition of a mandatory widget to the graphical user interface, the method further comprising:
the processor determining characteristics of the mandatory widget as a function of the repository of information characterizing widgets; and
the processor generating the test data as a function of the repository of data-generation rules.

19. The computer program product of claim 16, wherein the revising further comprises updating one or more repositories of the set of information repositories, and wherein the updating records the addition or deletion and identifies the revisions made to the script.

20. The computer program product of claim 15, further comprising:
the processor repeating the detecting, determining, revising, and retesting until the retesting determines that the revised script runs without error.
